(19) United States
(12) Patent Application Publication
(10) Pub. No.: US 2003/0036999 A1
(43) Pub. Date: Feb. 20, 2003

(54) Electronic presentation of invoices using a trusted document repository

(75) Inventors: Lev Mirlas, Thornhill (CA); Igor L. Tantsorov, Thornhill (CA)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/222,485

(22) Filed: Aug. 16, 2002

(30) Foreign Application Priority Data
Aug. 16, 2001 (CA) 2,355,785

(51) Int. Cl. G06F 17/60

(52) U.S. Cl. 705/40

(57) ABSTRACT

The invention provides a trusted repository for conveying invoices from a provider to a client. The repository includes a vault accessible by an authorized provider, a mechanism for depositing an invoice for a client from said authorized provider into said vault, and a mechanism for accessing a deposited invoice in said repository by said client.

### FIELD OF THE INVENTION

The present invention relates to a system and method for securely storing and providing access to documents over a network, and more specifically to a trusted document repository for providing authorized access to invoices and related invoice support documents over the Internet.

### BACKGROUND

The Internet has become a popular and convenient conduit for accessing information. Electronic commerce has enabled various companies to gain a strategic advantage within competitive markets. An important aspect of e-commerce is distributing and tracking payments for bills or invoices, which could be issued periodically to consumers of various commodities such as telephone, water, or electrical power and the like. To achieve this, various systems operate in secure environments, such as PKI (Public Key Infrastructure).

Terms such as ‘trusted’ and ‘untrusted’ are subjective judgements about a perceived capability of a system to prevent unauthorized access to ensure authorized access. User trust and confidence are significantly improved for trusted systems handling sensitive information, in which the information is protected from access by unauthorized persons. In contrast, users are not convinced that an untrusted system can prevent unauthorized access. For example, users place a higher degree of trust in the post office delivering a registered letter versus having the post office deliver a sensitive letter by ordinary mail.

Terms such as ‘secured’ and ‘unsecured’ are objective judgements about how well a system can prevent unauthorized access to information. Typically, secured systems include significant immunity from unauthorized access. In contrast, unsecured systems allow unauthorized persons to access information. For example, a courier could provide a secured delivery method, in which evidence of the security of the method could be ISO 9000 registration that objectively confirms that the delivery method follows documented steps. A degree of security related to a method or system should engender a corresponding degree of trust from users. There are other factors that may affect the level of trust of users, such as goodwill, or reputation of a method or system, psychological attitudes of users, and the legal environment. Strong security measures could engender an adequate degree of trust from users of a system that is administered by a third-party if the users were convinced that the system could: make access to documents very difficult for unauthorized users, record attempts at unauthorized access for future legal action against unauthorized users, and prevent a third-party administrator of the system from accessing user documents.

A vault can be considered to be a repository that is active on a third party information handling system that is trusted by the owner of the vault to prevent execution of programs other than those approved by the vault owner, and to retain exclusive access to private signature and encryption keys. These keys are not retrievable by anyone including the owner of the vault and are not accessible for use by other vaults, or by any other entity that has access to the third party system including the host or host administrator of the system.

Some information handling systems provide a method for distributing documents by using secured e-mail. Other systems include a secured or trusted document repository that can securely store documents. An example of a repository is a Vault Registry™ product manufactured by IBM™. User trust in a third-party host or administrator of a repository is not necessarily required because the repository prevents the administrator from accessing stored documents, while permitting the administrator to hold and store user documents. Ideally, a repository should be capable of managing user documents across various types of information handling computer systems supplied by various manufacturers over a network.

Hogan discloses—in U.S. Pat. No. 5,699,528 System and Method for Bill Delivery and Payment over a Communications Network dated Dec. 16, 1997—a communication network for bill delivery and payment by holding bills at a web site that is accessible from a web browser, and encrypting bills before transmitting the bills to users to prevent an eavesdropper from viewing or accessing contents of the bill during transmission.

Anderson discloses—in U.S. Pat. No. 5,283,829 System and Method for Paying Bills Electronically dated Feb. 1, 1994—an automated electronic bill payment method and system for transacting financial payment of bills between payee and payor financial institutions. This reference apparently discloses a method for directly transacting funds or payments, and restricts users from using a predetermined mode or channel of transacting funds for paying bills.

Hilt et al discloses—in U.S. Pat. No. 5,465,206 Electronic Bill Payment System dated Nov. 7, 1995—a bill payment method via a payment network using a predetermined communications protocol between billers and payers. This reference apparently only discloses using a predetermined, secured communications protocol.

Rosen discloses—in U.S. Pat. No. 5,745,886 Trusted Agents for Open Distribution of Electronic Money dated Apr. 28, 1998—an electronic purchasing system by using a trusted agent for both customers and merchants by transacting or exchanging ‘electronic money’ for purchases made over a network. This reference apparently only discloses that clients pay bills with electronic cash.

Chang et al discloses—in U.S. Pat. No. 5,884,288 Method and System for Electronic Bill Payment dated Mar. 16, 1999—an automated electronic bill payment system between payee and payor banks for exchanging funds using signed e-mail for securing bill content. This reference apparently only discloses a system for exchanging financial payments.

### SUMMARY OF THE PRESENT INVENTION

The present invention provides a method and a system including a trusted document repository for distributing electronic bills or invoices and other optionally associated documents, such as payment acknowledgements, over the Internet. A host site used for the repository can be managed by an administrator who is prevented from accessing stored documents by the security features of the repository. User trust in a third-party host is not a predetermined requirement that users must engender for the present invention.

According to a first aspect of the present invention, there is provided a trusted repository for conveying invoices from a provider to a client, including a vault accessible by an authorized provider, means for depositing an invoice for a client from the authorized provider into the vault, and means for accessing a deposited invoice in the repository by the client.

According to a second aspect of the present invention, there is provided a method for conveying an invoice from a provider to a client via a trusted repository including the steps of using a vault accessible by an authorized provider, depositing an invoice for a client from the authorized provider into the vault, and accessing a deposited invoice in the repository by the client.

According to a third aspect of the present invention, there is provided a computer program product for use in a computer system operatively coupled to a cowmputer readable memory, the computer program product including a computer-readable data storage medium tangibly embodying computer readable program code for directing the computer to conveying an invoice from a provider to a client via a trusted repository comprising a vault, the code including code for instructing the computer system to use the vault accessible by an authorized provider, code for instructing the computer system to deposit an invoice for a client from the authorized provider into the vault, and code for instructing the computer system to access a deposited invoice in the repository by the client.

A better understanding of these and other aspects of the invention can be obtained with reference to the following drawings and description of the preferred embodiments.

### BRIEF DESCRIPTION OF THE DRAWINGS

Reference is made to the accompanying drawings which show, by way of example, embodiments of the present invention, and in which:

FIG. 1 depicts an embodiment of a trusted repository for conveying invoices from a provider to a client;

FIG. 2 depicts operations of the repository of FIG. 1;

FIG. 3 depicts additional operations of the repository of FIG. 1;

FIG. 4 depicts another embodiment of a trusted repository adapted to operate with a bill payment system;

FIG. 5 depicts operations of the embodiment of FIG. 4;

FIG. 6 depicts other operations of the embodiment of FIG. 4;

FIG. 7 depicts additional operations of the embodiment of FIG. 4;

FIG. 8 depicts yet another embodiment of a trusted repository adapted to operate with one client and many providers; and

FIG. 9 depicts operations of the embodiment of FIG. 8.

### DETAILED DESCRIPTION OF THE PREFERRED EMBODIMENTS

The present invention provides a method and system for trusted distribution of electronic documents including bills, invoices or other documents via a repository that allows authorized users to access the documents over a network such as the Internet. The contents of the repository are protected from access by administrators of the repository giving access. Documents contained in the repository can include bills and associated documents, such as payment acknowledgements, bill notifications among others. The repository of the invention allows authorized users to securely search and access their own documents. In one aspect of the invention, authorization can be given to users to access documents stored in the repository that belong to other users with their agreement. In another embodiment of the invention, stored documents can be securely and transparently transferred between repositories. Another aspect of the present invention securely presents bills in a non-repudiation manner, facilitates payments of the bills, and collects evidence of bill payments in a non-repudiation manner.

The present invention can be used by various individuals and organizations, such as providers of goods or services that need to issue bills for secure delivery to clients and protect or confirm transacted payments. The invention can be used by others for secure business transactions such as by collection agencies that may be requested to process bills or collections on behalf of others.

In another aspect provided by the invention is a repository adapted to deliver bill notifications to clients for announcing that new bills have been deposited and are awaiting access from the repository. A repository can provide a bill received acknowledgement, which can indicate that a client accessed or retrieved a bill from the repository. Clients could also be given access to a history of a bill, which could show when the bill was stored in the repository, or dates when the bill was viewed by a client, and other accesses.

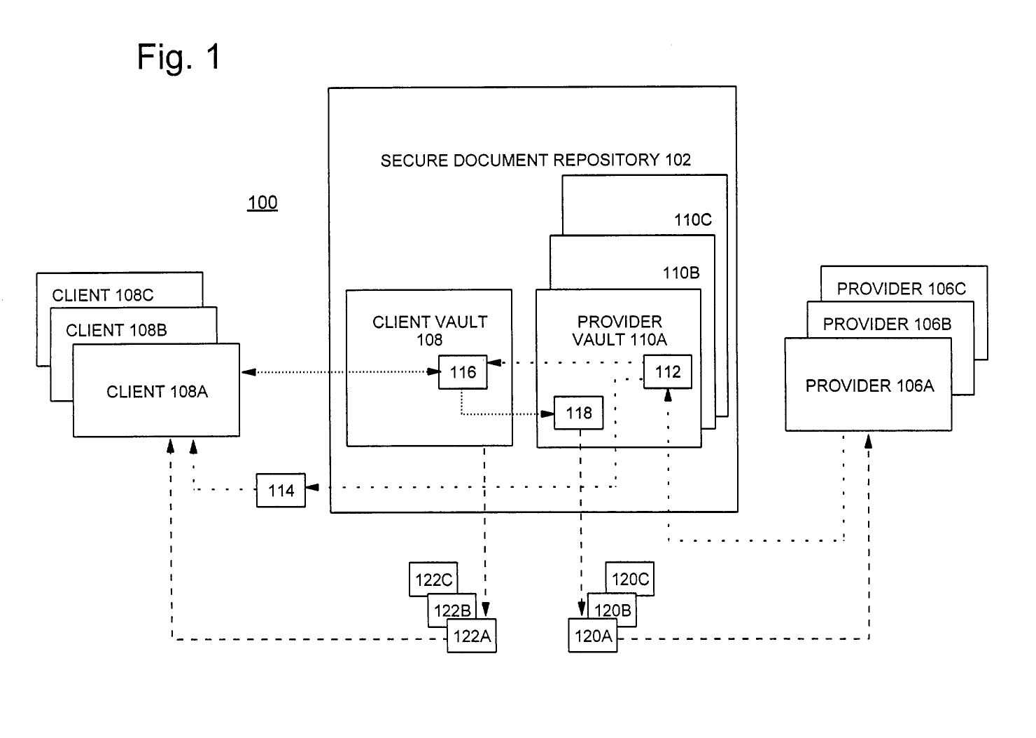

Referring to FIG. 1, there is depicted an embodiment 100 of the invention. A secured document repository 102 is securely accessible by providers 106 and clients 104. The repository includes client vaults 108, which are accessible by the clients 104, and provider vaults 110, which are accessible by the providers 106.

An example of a trusted repository is the IBM Vault Registry, which is a security-rich, integrated registration and certification solution that aims to build trust into business-critical web applications. By using Vault Registry, organizations can establish the level of trust they need to conduct e-business on the Internet. IBM Vault Registry integrates innovative “vault” software with a flexible registration application to ensure that online business can be conducted with the same confidence enjoyed in the physical world. It allows customers to identify the people and organizations with whom they do business online. IBM vault software uses encryption that isolates data and applications by responsibilities and roles—including protection from unauthorized system administrators and operators. Using digital certificates for authentication and access control, it protects data in special areas of memory or “vaults” against unauthorized access. IBM Vault Registry maintains auditable logs of all registration and certificate processing transactions.

The clients 104 receive electronic bills or invoices which are issued and deposited by the providers 106 into the repository 102. The repository 102 is securely accessed by the clients 102 and the providers 106 over a secured network, such as a web browser operating with a SSL (Secure Socket Layer) over the Internet. Provider vaults 110A, 110B, 110C are exclusively assigned to a corresponding authorized provider 106A, 106B, 106C respectively. The vaults 110 are accessed by authorized providers 106. Clients 102 share a client vault 108, which is also called a common vault 108. Provider 106A deposits a bill 112 in an electronic format into an assigned corresponding provider vault 106A and a copy 116 of the deposited bill 112 is placed in the client vault 108. The repository 102 send a bill notification 114 to a client 104A which states that a copy 116 of the bill 113 has been recently deposited into the client vault 108. Once the client 104A retrieves or accesses the copy of the deposited bill 116A from the client vault, the repository 102 responds by generating a non-repudiation receipt 118 that indicates the client 114A retrieved the copy 116 of their bill 112. A convenient report 120A is generated which includes a summary of all received non-repudiation receipts for a predetermined time period, and the report 120A is delivered to the provider 106A. If desired, clients 104 can access a summary 122 of their received and/or paid bills. Bills and receipts can be removed from the repository 102 under the discretion of providers 106, in which case the repository 102 responds to the removal of electronic documents by starting a new reporting period for reports 120.

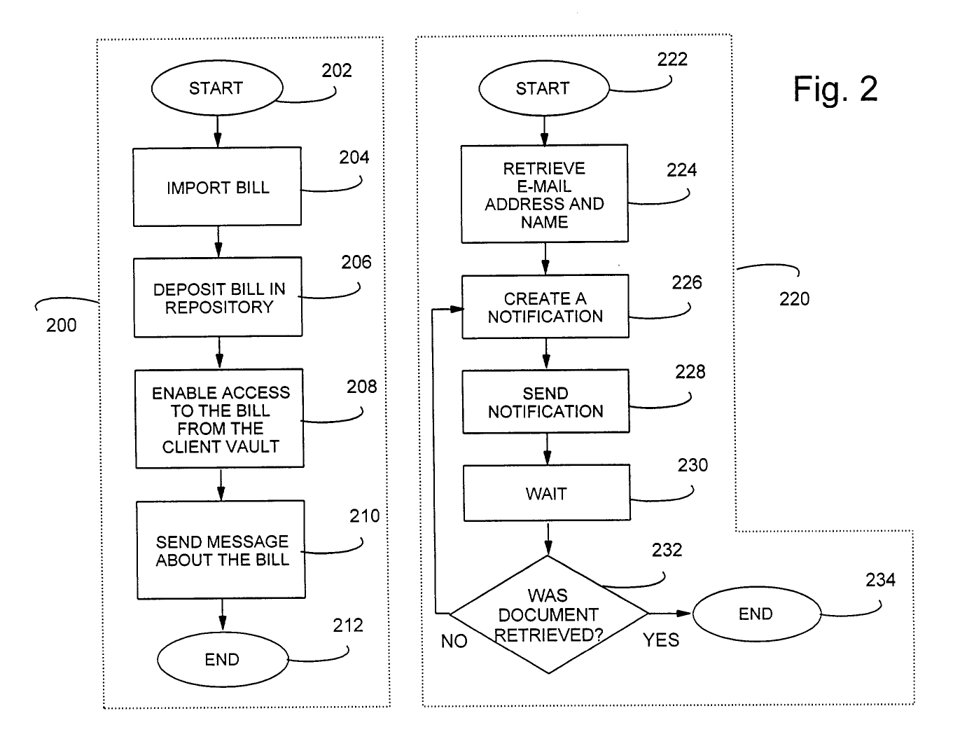

Referring to FIG. 2, there is depicted operations of the repository 102 of FIG. 1 for depositing bills 112 submitted by providers 106. It will be understood that the operations of flowchart 200 and 220 are performed by the repository 102 unless otherwise stated. Following flowchart 200, S202 begins the operations in which the repository 102 is ready for secured communications with providers 116 and ready to receive various bills. S204 imports the bills into the repository 102. A provider can enter the bill data of the bill can be retrieved from a computer readable medium or can be entered manually via a keyboard. Once the bill is imported into the repository 102, S206 stores the bill within a provider vault 110 which is corresponds or is assigned to the provider of the bill. An attribute can be conveniently assigned to the imported bill for identifying the client that will receive the imported bill. The attribute can be used for searching for bills that belong to a specific clients. Once the imported bill is stored in the provider's assigned vault, S208 enables access to a copy 116 of the stored imported bill 112 by an authorized client 104A from within a client vault 108. Once the copy of the bill is stored in the client vault, S210 sends a bill notification 114 to the client 104A. The bill notification 114 indicates that a newly deposited copy 116 of the bill 112 is available for access. For convenience, the bill notification includes a name of the provider that issued and forwarded the bill to the repository 102. S212 ends the operations.

Following flowchart 220, S222 begins the process of creating bill notifications for notifying clients that bills are available for access from the client vault of the repository 102. When the repository 102 is ready to create bill notifications, S224 retrieves client addressing information for the bill notification such as an e-mail address, an encryption key such as a public key, and personal information such as a client title. Conveniently, the client information can be located from a directory such as an X500 Directory. Once the addressing information and encryption key are retrieved, S226 creates a bill notification. A template can be used for creating bill notifications when producing a large number of bill notifications. The template can conveniently include a logo of the bill provider and/or a URL (Uniform Resource Locator) link that points to a copy of the deposited bill. Optionally, several URL links can be included in the bill notification for pointing to a repository domain, a processing application, a name or identification of a provider, and/or a document identification. To ensure confidentiality of the bill data, the bill notification does not contain any bill data such as the amount payable and/or the due date. The created bill notification is signed by the provider and is then encrypted with a public key that is assigned to the provider. Once the bill notification is created, S228 sends or forwards the created bill notification to a client by secure e-mail over the Internet. The bill notification can be conveniently viewed by an e-mail program. After forwarding the created bill notification, S230 waits for a predetermined time period. S232 determines whether a non-repudiation receipt exists. The non-repudiation receipt provides evidence that the created bill notification was received and the bill was retrieved from the repository 102 by a client. For the case when a client does not retrieve the bill within a predetermined time period, processing can continue to S228 in which a new bill notification can be created and sent to the client. S234 ends the operations.

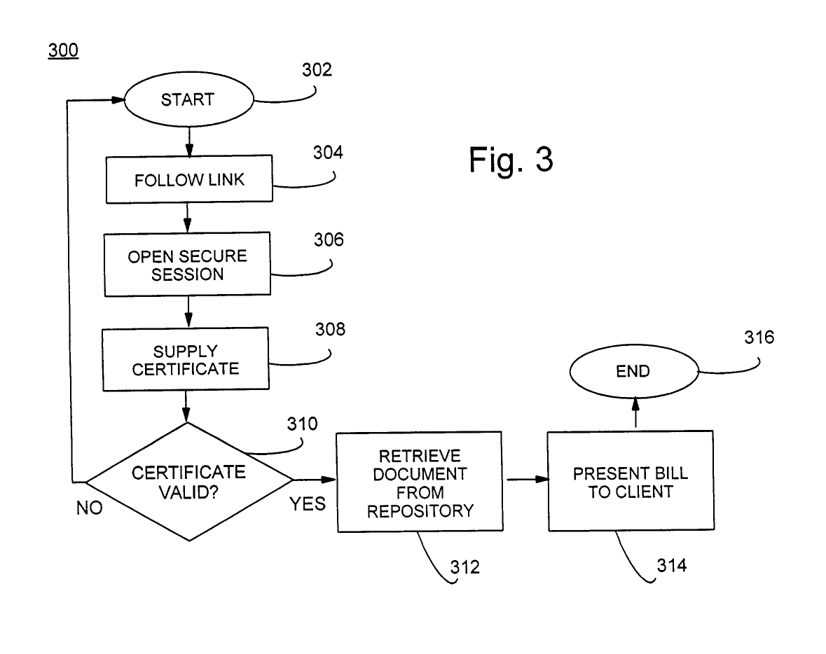

Referring to FIG. 3, there is depicted operations of the repository 102 of FIG. 1 for allowing clients to retrieve copies of stored bills from the repository 102. For improved performance, operations of flowchart 300 includes the use of an URL link embedded in the created bill notification for pointing to the copy of the created bill stored in the repository. It will be understood that the operations of flowchart 300 is performed by the repository 102 unless otherwise stated. The repository 102 is ready and S302 begins the operations. In S304, the client follows the a URL link embedded in a bill notification. In S306, the client opens or begins secured communications with the repository 102 after which the repository 102 accept a bill retrieval command from the client. The bill retrieval command can conveniently include a ‘point and click’ operation from a keyboard or mouse which selects the URL link embedded in a bill notification that the client received and opened for viewing. The URL link is conveniently included with a delivered bill notification so that the client can follow the URL link via a client web browser. Once a secure session between a repository and the client is established, the S308 accepts a request for validating an SSL certificate supplied by the client. S310 determines whether the connection is validated as being secured. If not secured, then processing can continue from S302. If the certificate is validated successfully, S312 retrieves a copy of the stored bill in which the copy is located or obtained from a client vault 108. Once the copy of the bill is retrieved, a non-repudiation receipt is generated and sent to a provider vault assigned to the provider of the stored bill, and the non-repudation receipt is stored along with the bill. Once the receipt is generated, S314 sends the copy of the bill stored in the client vault to the client browser and the bill is presented to the client. The repository 102 can wait for a predetermined time period for the client to retrieve the copy of the stored bill. If the client does not retrieve the copy of the stored bill within the predetermined time period after sending a bill notification, the repository automatically sends another bill notification and waits for another predetermined time period for the client to retrieve the copy of the stored bill. Alternatively, the repository can be adapted to send a predetermined number of bill notifications at regular time intervals until the client retrieves the copy of the stored bill. S316 ends the operations.

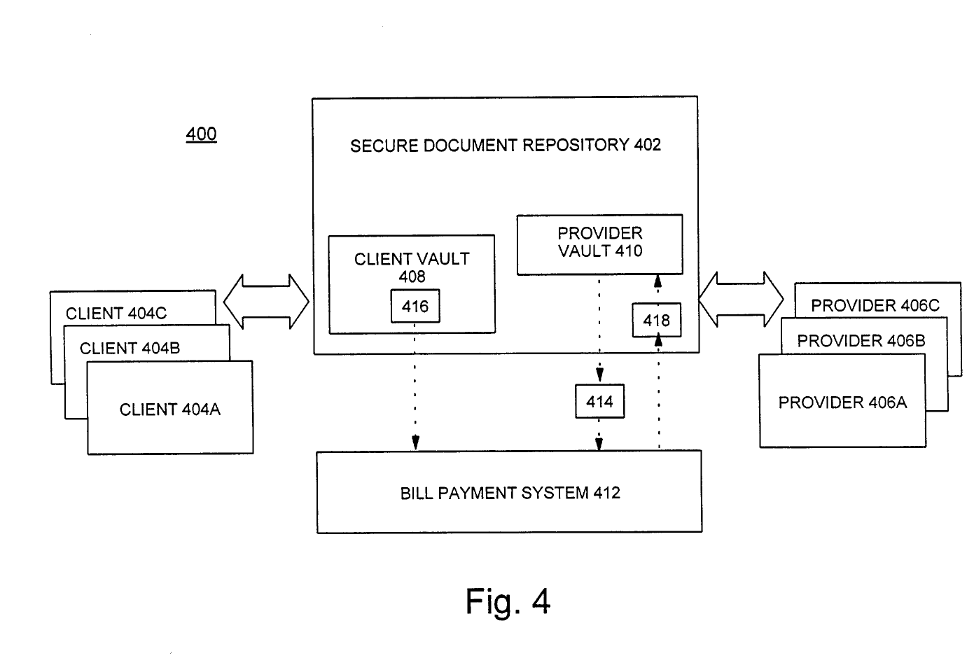

Referring to FIG. 4, there is depicted another embodiment 400. A repository 402 includes operations for storing and distributing bills, facilitating financial transactions for the stored bills, and issuing payment acknowledgements for confirming that providers received payments for delivered stored bills. Repository 402 includes provider vaults 410, which are assigned to various providers 406, and a client vault 408, which is accessible by the clients 404. Repository 402 cooperates with an existing bill payment system 412, in which the repository 402 forwards bill payment information 414 to the bill payment system 412 which in turn transacts payment of bills based on the bill payment information 414. It will be understood that the bill payment system 412 completes the transaction of monetary payments of bills. Payment system 412 is beyond the scope of the present invention. Providers 406 may already be using an existing payment system which may be currently suitable for their needs. For example, providers may be using an existing credit card infrastructure for transacting payments for bills over the Internet. The repository 402 can be adapted to provide bill payment information 414 formatted for various existing payment systems 412 from which a client can choose a preferred payment system. The repository 102 is adapted to operate as a gateway to existing bill payment systems 412 over a network, such as the Internet. A stored bill 416 include a URL link for linking clients to existing bill payment systems 412, which then can initiate transaction for payment of the stored bill. Alternatively, a stored copy of a bill 416 includes structured bill data in which actual bill data is separated from bill presentation data that contains a name of the bill provider, address, phone number contacts, and the like. The repository 402 provides a suitable payment interface for interfacing with existing bill payment systems 412. The payment interface provides an entry point for payment records 418 for tracking transacted payments of stored bills. Payment records 418 indicates proof of payment. Record 418 can be conveniently accessed by either clients 404 or providers 406. Payment record 418 can be created by providers 406 after the providers 406 receive payments. Alternatively, the clients 404 can have correspondingly assigned client vaults, or clients can share a common-client vault. The clients 404 have secured access to copy of bill 416 and the payment record 418. Alternative operations include importing structured bill data, feeding bill data from a stored bill to a payment system via a web browser, and depositing a payment record 418 for confirming payment of a bill. The repository 402 can be adapted to respond to payment of bills by stopping any further sending of additional bill notifications to clients, and can be adapted to provide a history of bill payments to users.

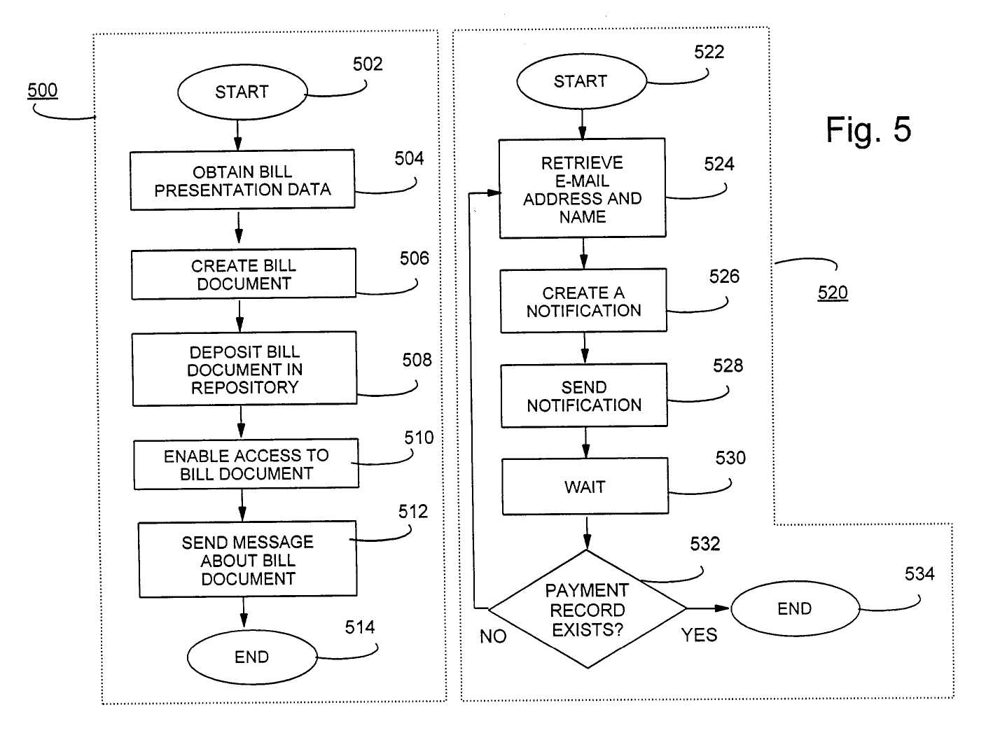

Referring to FIG. 5, there is depicted operations of the repository 402 of FIG. 4 for creating bills. It will be understood that the operations depicted in FIG. 5 are performed by the repository 402 unless stated otherwise. S502 begins the operations of flowchart 500. After the repository 402 is ready, S504 accepts or imports bill presentation data. The presentation of the bill occurs over a secured network such as a web browser and the Internet via SSL. A screen template is used for presenting contents of the bill. A query template can be used for specific payment protocols and URLs for paying bills. The bill presentation data is structured in a predetermined financial industry-accepted format such as EDI (Electronic Data Interchange) or similar. After the bill presentation data is imported, S506 creates bills by using a template for containing and presenting the actual presentation data. Once the bill is created, S508 deposits the created bills into the repository 402. Optionally, a client attribute can be assigned to the created bill, the attribute identifies the client 404. The attribute can be used for searching purposes. S510 enables accesses for the created bill from the client vault 408. S512 sends, to clients, bill notifications indicating that deposited bills are available for access. A bill notification can include a name of the client and/or the provider. S514 ends the operations.

Referring to flowchart 520, there is depicted operations of the repository 402 of FIG. 4 for creating bill notifications and checking whether a payment record exists for the delivered bill notification. S522 begins the operations of repository 402. S504 obtains details about a client, such as an e-mail address, a title of a client, and other optional information about the client. Personal address information about the client can be obtained from a directory, such as the X500 Directory. Once the client information is obtained, S526 creates a bill notification. Bill notifications are created by using a notification template. Alternatively, the bill notification contains a URL link so that a client can point and click the URL link to access the stored bill. The URL link can point to a repository domain, a processing application, an identification for identifying a provider that supplied the bill, and/or a document identification such as a serial number for identifying a bill. The bill notification contains only a notice that a bill is awaiting to be retrieved by the client and does not contain actual bill data of the stored bill. Once the bill notification is created, the bill notification can be signed. Alternatively, an encrypted bill notification can be created to ensure confidential delivery of the bill notification. The bill notification is encrypted with an encryption key, such as a public key of a client. The encryption key can be assigned to each client and stored with the personal information of the client. S528 sends the encrypted bill notification to a client over a network, such as e-mail over the Internet. S520 waits for a predetermined period of time before checking whether a bill was retrieved and paid. If a bill was not retrieved and paid, a new notification can be issued to a client. A non-repudiation receipt is generated in response to a client accessing and paying a stored bill. The non-repudiation receipt indicates that the stored bill was retrieved from the repository and payment was transacted for the stored bill. S534 ends the operations.

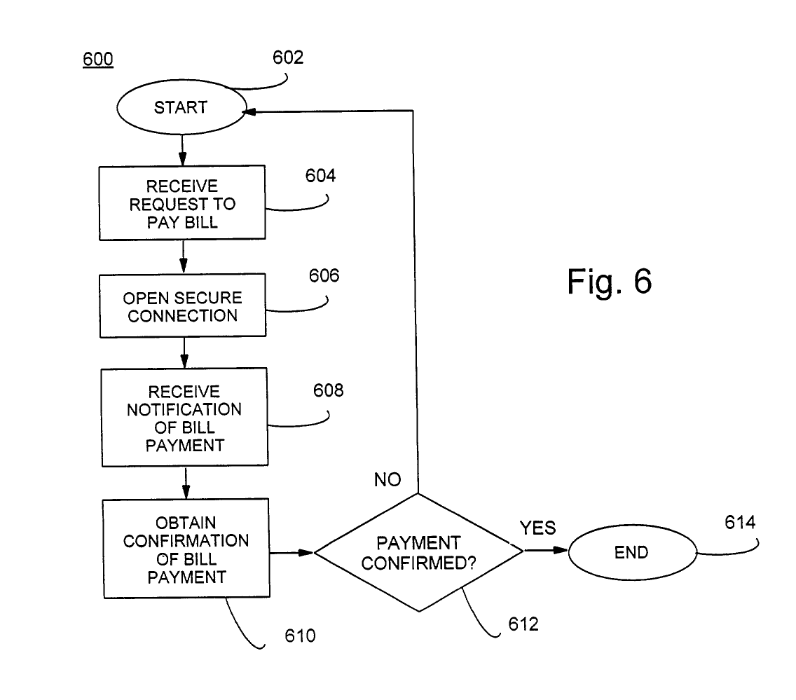

Referring to FIG. 6, there is depicted operations of the repository 402 of FIG. 4 for directing a client to a payment system via a URL link contained within a bill. It will be understood that the operations depicted in FIG. 5 are performed by the repository 402 unless stated otherwise. Alternatively, clients can deal directly with their preferred payment systems without having to use the operations depicted in the flowchart 600 of FIG. 6. It will be appreciated that the operations of flowchart 600 provides convenient features for helping the clients to deal with their favored payment system. S602 starts the operations. Once the repository 402 is ready, S604 reads bill payment data from a client. Bill payment data can include an identification for a payment system, an identification for a provider, a bank account number of a provider, an amount of money to be deposited into the bank account number of a provider, a credit card identification of a client, and/or a bank account number of a client. The bill presented to the client contains input fields for inputting payment data from the client. Once the data is read by repository 402, S606 opens secured connection with the bill payment system thereby initiating the payment system to transact payment for the bill, such as opening a secure connection to the payment system over the Internet. Transfer of money can be enabled by using an applet and the like. Once the repository receives a notification of bill payment in S608, S610 obtains a payment confirmation from the payment system. Any of the steps of FIG. 6 can be repeated in case of a communication failure. Additional steps are taken when payment of money has not been transacted within a predetermined time period, such as sending additional bill notifications. S614 ends the operations.

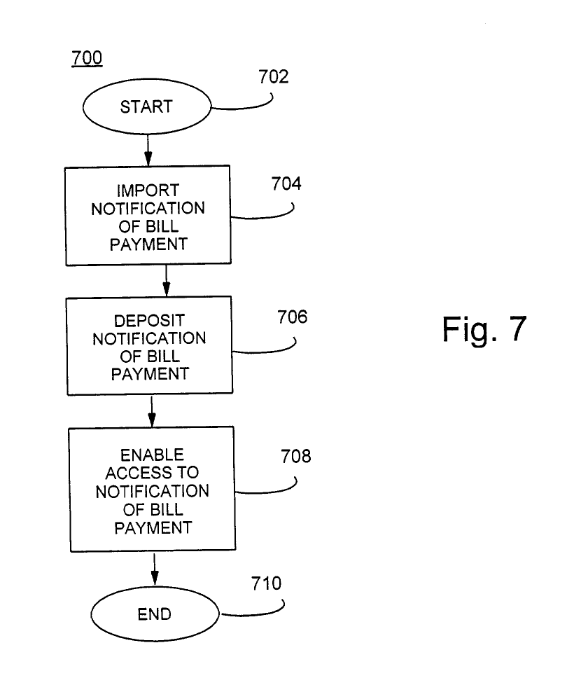

Referring to FIG. 7, there is depicted operations for receiving payment records that confirm payment for bills. It will be understood that the operations depicted flowchart 700 are performed by the repository 402 of FIG. 4 unless stated otherwise. S702 begins the operations. S704 imports a bill payment record from a bill payment system in response to the bill payment system completing transaction for payment of the bill. The bill payment record has a structured format and the bill payment record contains assigned attributes for enabling search capabilities. After importing the bill payment record, S706 deposits the bill payment record in the vault of the repository 402. S708 enables the bill payment records for accessibility, which can include making the bill payment records accessible via a provider vault and/or the client vault. Existence of the bill payment record terminates future delivery of the bill notifications and also provides non-refutable proof to the client that the bill payment was received by a provider. S710 ends the operations.

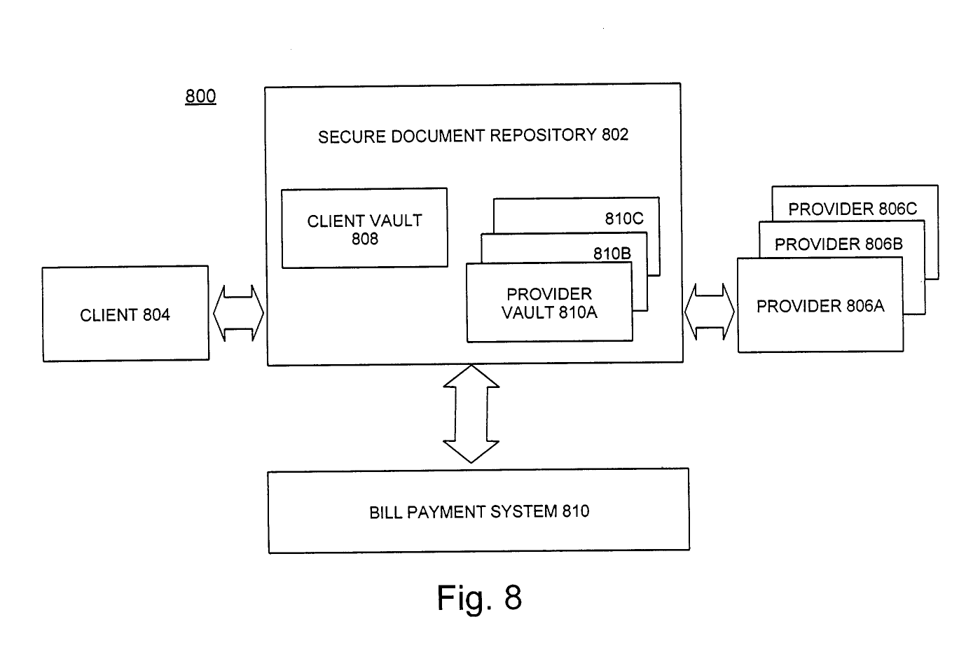

Referring to FIG. 8, there is depicted yet another embodiment for storing, distributing, and facilitating payment of money between a plurality of providers (12) and one client (14). Repository 802 is adapted for operation as a business to business interaction, in which a single client 804 receives bills from various providers 806. Preferably, each provider 806A, 806B, 806C and the client 804 are assigned respective provider vault 810A, 810B, 810C and a client vault 808.

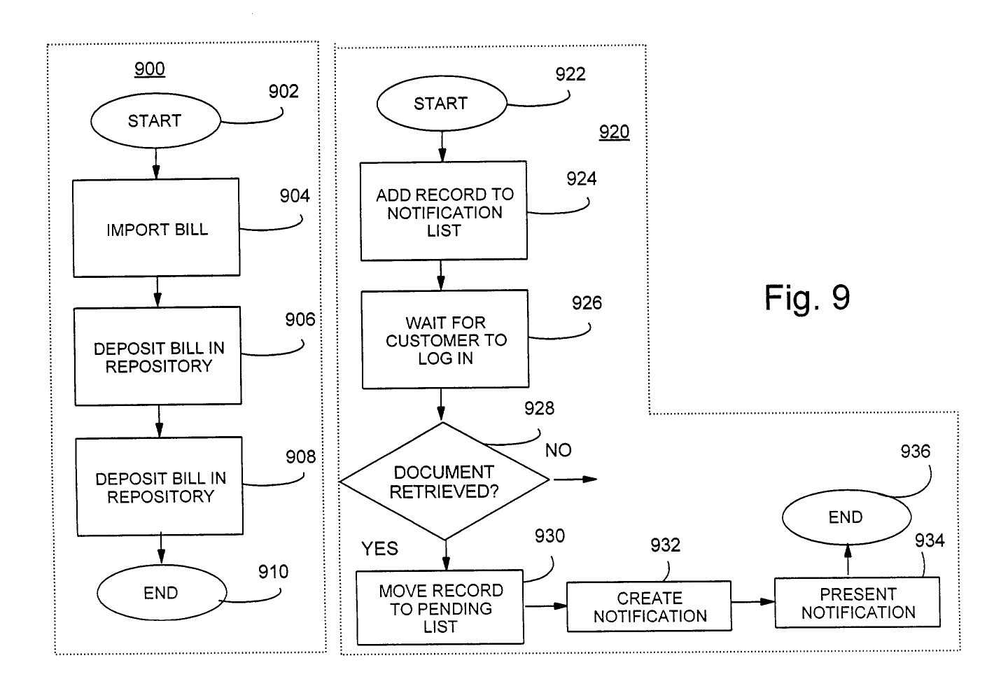

Referring to FIG. 9, there is depicted operations of the repository 802 of FIG. 8 for importing bills. It will be understood that operations depicted in FIG. 9 are performed by the repository 802 unless stated otherwise. S902 begins the operations. S904 imports bills having bill data from providers. S906 deposits the bills into a repository. The bill contains bill data and other information such as a name of the client. S908 marks the imported bills as accessible by at least one client vault. S910 stops the operations.

Referring to flowchart 920, there is depicted operations of repository 802 for notifying a client about a recently deposited bill is shown. S922 begins the operations. Once repository 802 is ready, S924 adds a record to the notification list. S926 waits for a client to log in. Once a client has logged in, S928 determines whether a bill was retrieved from the repository 802. If the bill was deposited and retrieved, then processing continues to S930 in which the bill is moved to a pending list. Viewed bills are moved to a list of pending bills when a non-repudiation retrieval receipt exists for any bill contained in a notification list. The report is managed by a vault of the client.

However, in S928, if the bill was determined to have been deposited but was not retrieved, then processing continues to S932 in which a bill notification is created. A notification template is used for creating the bill notification. The bill notification contains information about how to obtain the bill. The bill notification includes a URL link so that an authorized user can point and click the URL link to access the bill. S934 presents bill notifications to the client. This step can be performed in response to the client logging into the repository. A notification report includes a notification list, a list of pending bills, and a link to an application or a function for retrieving a bill notification report. Pending bills are bills that were retrieved but have not paid, so there is no bill payment record for them. Alternatively, the repository can add the bill notification to a notification list, or build a bill notification report so that the client can choose which bills will be retrieved for payment approval.

It will be appreciated that the present invention can be incorporated in a computer program product that includes a computer-readable medium, such as a floppy disk or a CD, tangibly including executable software instructions for instructing a computer to carry out the process of the present invention. The program product can also be distributed via a signal containing the software instructions over a communications network such as the Internet.

Having thus described the present invention, it will be apparent to those skilled in the art that various modifications and enhancements are possible to the present invention without departing from the basic concepts as described in the preferred embodiment. Therefore, what is intended to be protected by way of Letters Patent is set forth in the following claims as description and not limitation.

What is claimed is:

1. A trusted repository for conveying invoices from a provider to a client, comprising:
a vault accessible by an authorized provider;
means for depositing an invoice for a client from said authorized provider into said vault; and
means for accessing a deposited invoice in said repository by said client.

2. The trusted repository of claim 1 further comprising means for sending a notification of said deposited invoice to said client.

3. The trusted repository of claim 2 further comprising means for sending an acknowledgement of client access of said deposited invoice to said authorized provider.

4. The trusted repository of claim 3 further comprising:
means for providing a report of deposited invoices to said authorized provider;
means for communicating deposited invoice information to a bill payment system; and
means for receiving invoice payment information from said bill payment system.

5. The trusted repository of claim 1 wherein said vault comprises:
a provider vault accessible by said authorized provider; and
a client vault accessible by an authorized client;
wherein means for depositing said invoice is adapted to deposit said invoice for said client from said authorized provider into said provider vault;
the trusted repository further comprises means for representing said deposited invoice in said client vault; and
wherein means for accessing said deposited invoice is adapted to access said deposited invoice by said authorized client from said client vault.

6. The trusted repository of claim 5 wherein said means for representing said deposited invoice in said client vault transfers a copy of said deposited invoice from said provider vault to said client vault.

7. The trusted repository of claim 6 wherein said means for sending said notification of deposit of said invoice is adapted to send said notification of deposit of said invoice in said client vault to said client.

8. The trusted repository of claim 7 further comprises means for sending an acknowledgement of client access of said deposited invoice to said provider.

9. The trusted repository of claim 8 further comprising:
means for providing a report of deposited invoices to said authorized provider;
means for communicating deposited invoice information to a bill payment system; and
means for receiving invoice payment information from said bill payment system.

10. The trusted repository of claim 9 further comprising:
means for assigning an identification attribute to said deposited invoice as an aid for searching for said deposited invoice; and
means for searching for said deposited invoice based on said identification attribute.

11. The trusted repository of claim 9 further comprising:
means for embedding a URL link into a deposited invoice for linking to said bill payment system; and
means for embedding a URL link pointing to a deposited invoice into said notification of deposit of said deposited invoice to assist client access of said deposited invoice.

12. The trusted repository of claim 10 further comprising:
means for encrypting said notification of deposit of said invoice before forwarding said notification of deposit to a client.

13. A method for conveying an invoice from a provider to a client via a trusted repository having a vault comprising the steps of:
depositing an invoice for a client from an authorized provider into said vault; and
accessing said deposited invoice in said repository by said client.

14. The method of claim 13 further comprising the step of sending a notification of said deposited invoice to said client.

15. The method of claim 14 further comprising the step of sending an acknowledgement of client access of said deposited invoice to said authorized provider.

16. The method of claim 15 further comprising the steps of:
providing a report of deposited invoices to said authorized provider;
communicating deposited invoice information to a bill payment system; and
receiving invoice payment information from said bill payment system.

17. The method of claim 13 wherein said vault comprises:
a provider vault accessible by said authorized provider; and
a client vault accessible by an authorized client;
the method comprising the steps of:
depositing said invoice for said client into said provider vault;
representing said deposited invoice in said client vault; and
accessing said deposited invoice by said authorized client from said client vault.

18. The method of claim 17 wherein the step of representing said deposited invoice in said client vault comprises transfering a copy of said deposited invoice from said provider vault to said client vault.

19. The method of claim 18 wherein the step of sending said notification of deposit of said invoice comprises sending said notification of deposit of said invoice in said client vault to said client.

20. The method of claim 19 further comprises the step of sending an acknowledgement of client access of said deposited invoice to said provider.

21. The method of claim 20 further comprising the steps of:
providing a report of deposited invoices to said authorized provider;
communicating deposited invoice information to a bill payment system; and
receiving invoice payment information from said bill payment system.

22. The method of claim 21 further comprising:
assigning an identification attribute to said deposited invoice as an aid for searching for said deposited invoice; and
searching for said deposited invoice based on said identification attribute.

23. The method of claim 21 further comprising:
embedding a URL link into a deposited invoice for linking to said bill payment system; and
embedding a URL link pointing to a deposited invoice into said notification of deposit of said deposited invoice to assist client access of said deposited invoice.

24. The method of claim 22 further comprising:
encrypting said notification of deposit of said invoice before forwarding said notification of deposit to a client.

25. A computer program product for use in a data processing system for distribution of electronic documents using a trusted document repository having a vault, said computer program product including a computer-readable data storage medium tangibly embodying computer readable program code for directing said data processing system to convey an invoice from a provider to a client via said vault, said program code comprising:
code for instructing said data processing system to deposit an invoice for a client from an authorized provider into said vault; and
code for instructing said data processing system to access a deposited invoice in said repository by said client.

26. The computer program product of claim 25 further comprising code for instructing said data processing system to send a notification of said deposited invoice to said client.

27. The computer program product of claim 26 further comprising code for instructing said data processing system to send an acknowledgement of client access of said deposited invoice to said authorized provider.

28. The computer program product of claim 27 further comprising:
code for instructing said data processing system to provide a report of deposited invoices to said authorized provider;
code for instructing said data processing system to communicate deposited invoice information to a bill payment system; and
code for instructing said data processing system to receive invoice payment information from said bill payment system.

29. The computer program product of claim 25 wherein said vault comprises:
a provider vault accessible by said authorized provider; and
a client vault accessible by an authorized client;
said program code comprising:
code for instructing said data processing system to deposit said invoice for said client from said authorized provider into said provider vault;
code for instructing said data processing system to represent said deposited invoice in said client vault; and
code for instructing said data processing system to access said deposited invoice by said authorized client from said client vault.

30. The computer program product of claim 29 wherein the code for instructing said data processing system to represent said deposited invoice in said client vault comprises code for instructing said data processing system to transfer a copy of said deposited invoice from said provider vault to said client vault.

31. The computer program product of claim 30 wherein the code for instructing said data processing system to send said notification of deposit of said invoice comprises code for instructing said data processing system to send said notification of deposit of said invoice in said client vault to said client.

32. The computer program product of claim 31 further comprises code for instructing said data processing system to send an acknowledgement of client access of said deposited invoice to said provider.

33. The computer program product of claim 32 further comprising:
code for instructing said data processing system to provide a report of deposited invoices to said authorized provider;
code for instructing said data processing system to communicate deposited invoice information to a bill payment system; and
code for instructing said data processing system to receive invoice payment information from said bill payment system.

34. The computer program product of claim 33 further comprising:
code for instructing said data processing system to assign an identification attribute to said deposited invoice as an aid for searching for said deposited invoice; and
code for instructing said data processing system to search for said deposited invoice based on said identification attribute.

35. The computer program product of claim 33 further comprising:
code for instructing said data processing system to embed a URL link into a deposited invoice for linking to said bill payment system; and
code for instructing said data processing system to embed a URL link pointing to a deposited invoice into said notification of deposit of said deposited invoice to assist client access of said deposited invoice.

36. The computer program product of claim 34 further comprising:
code for instructing said data processing system to encrypt said notification of deposit of said invoice before forwarding said notification of deposit to a client.
